(19) United States
(12) Patent Application Publication
(10) Pub. No.: US 2016/0260254 A1
(43) Pub. Date: Sep. 8, 2016

(54) RENDERING DIGITAL CONTENT BASED ON TRIGGER INFORMATION

(71) Applicant: Calay Venture S.à r.l., Bettembourg (LU)

(72) Inventor: Cevat Yerli, Frankfurt am Main (DE)

(73) Assignee: Calay Venture S.à r.l., Bettembourg (LU)

(21) Appl. No.: 14/635,735

(22) Filed: Mar. 2, 2015

(51) Int. Cl. G06T 19/00; H04L 29/08; G06T 11/60; H04L 29/06

(52) U.S. Cl. CPC G06T 19/006; H04L 65/4069; H04L 67/306; G06T 11/60

(57) ABSTRACT

A method of providing digital content on an electronic device is disclosed. The method is for use with a card including trigger information, wherein the trigger information is printed on the card and removably covered by a coating, the method comprising gathering, by means of a camera, the trigger information exposed due to removal of the coating, and, based on the gathered trigger information, rendering the digital content on the electronic device. Furthermore, an electronic device and a system for use with a plurality of cards are disclosed.

### FIELD

The present disclosure relates to a method, an electronic device and a computer system for controlled provision of digital content based on trigger information. The trigger information can be printed on a card and may be concealed by an opaque, removable panel.

### BACKGROUND

Scratch cards are physical entities comprising one or more areas on which information is printed. The information is concealed by an opaque panel which can be scratched off to reveal the information. The revealed information may provide some advantage. For instance, it may effect the disbursement of a gain when it is presented for the first time to a provider of a gambling service, or it may serve as a one-time password (such as a code number) which, when being entered into some device for the first time, releases some service, credit or access right such as phone services or other prepaid services. Due to the information being covered by the panel, a holder or recipient of the scratch card can be assured that the information has not been used so far and thus is still valid.

However, such conventional use of scratch cards is very static and requires human interpretation of the exposed information which, therefore, may not be complex information. As a consequence, the variety of benefits, functions or performances offered by means of a batch of scratch cards is small and does not measure up, in particular, to the variety of possible digital content the provision of which on an electronic device may be desirable.

There is, therefore, a need for a technique supporting a more diversified utilization of scratch cards allowing for a provision of digital content on an electronic device.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to the present disclosure, the above issues are solved by a method of providing digital content on an electronic device, by an electronic device and a system for use with a plurality of cards.

According to a first aspect of the present disclosure, a method of providing digital content on an electronic device is disclosed, the method for use with a card including trigger information which is printed on the card and removably covered by a coating. The method comprises gathering, by means of a camera, the trigger information, which is exposed due to removal of the coating; and rendering, based on the gathered trigger information, the digital content on the electronic device.

According to a second aspect of the present disclosure, an electronic device includes a processor, a camera and a display, and is adapted to provide digital content when used with a card including trigger information printed on the card and removably covered by a coating. The electronic device is configured to gather, by means of the camera, the trigger information exposed due to removal of the coating; and based on the gathered trigger information, to render the digital content.

According to a third aspect, a system for use with a plurality of cards including trigger information printed on each card and removably covered by a coating is disclosed. The system comprises at least one electronic device and at least one server configured to communicate with the at least one electronic device. Each electronic device is configured to gather, by means of a camera of the electronic device, trigger information exposed due to removal of a coating of one of the plurality of cards, and based on the gathered trigger information, to render digital content on the electronic device.

Accordingly, when a user has removed (e.g., scratched off) the coating to thereby expose the trigger information and present the trigger information to the camera of the client device, the trigger information is automatically gathered by the electronic device. The trigger information can thus be automatically interpreted, so that complex information can be encoded in the trigger information. In particular, the trigger information can identify a particular card, which allows an automatic redemption process by registering when the trigger information of the particular card has been used. Moreover, the trigger information can identify a variety of possible digital content to be rendered on the electronic device.

The present disclosure further provides the advantage that a decision about which particular digital content is to be rendered upon gathering particular trigger information can be made, by a provider of the card, after the card has been printed, as the respective automatic determination of the digital content can be programmed accordingly.

Hence, the method, electronic device and system of the present disclosure introduces the concept of conventional physical scratch cards into the employment of electronic devices, operations and functionalities of which may be enhanced based on the trigger information exposed on the scratch card. In particular, a dynamic utilization of the scratch cards is thereby facilitated. The concept according to the present disclosure thus enables an advantageous utilization of printed scratch cards, by immersing users in a digital world and providing innumerable opportunities to keep up or keep ahead of developments, and to respond quickly to changes by adjusting the digital content to current needs and conditions.

As conventional scratch cards, each card may be created by a publisher, provider or sponsor and distributed through physical distribution channels. Moreover, the recipients thereof can pass on unredeemed cards to their friends, associates or the general public, wherein unredeemed cards can be passed on an infinite number of times. An unredeemed card may be a card where the trigger information is still covered by the coating of the card. However, an unredeemed card may also be a card, where the trigger information is revealed, however, where the trigger information has not been gathered by an electronic device and/or a respective digital content has not been requested and rendered on the electronic device based on the trigger information.

The delivered and rendered digital content could take any type and format, which could depend on a message the card provider intended to convey to the user of the card.

The digital content may be overlaid over a recording of the trigger information (such as a video or live-view thereof) being recorded by the camera of the electronic device. The recording with the overlaid digital content may then be displayed on a display of the electronic device.

As a particular example, the digital content may be rendered using augmented reality techniques. Augmented reality (AR) is known in the art as a live direct or indirect view of a real environment whose elements are augmented or supplemented by computer-generated content, such as audio, video, graphics or the like. The real world is typically augmented in real time and in a semantic context with environmental elements, such as the trigger information, which could be used to register and/or anchor the digital content in the real world. By overlaying the digital content on the recording of the real world, the presented digital content becomes interactive and digitally manipulable within the real world. In particular, the digital content may be locked to a position and orientation of the trigger information within the recording and may be rendered according to a position, orientation and/or a current camera perspective on the trigger information, in order to deliver a realistic view of the digital content on the trigger information within the real world.

An electronic device as referred to herein may be a smartphone, a PC, a notebook, a tablet computer, special headset or glasses, or any other electronic device including a processor, a display, and a camera.

As further used herein, the term “server” may refer to one or more computers hosting software applications in a network environment. Alternatively, it may refer to a software server, i.e., to any computerized process that shares a resource to one or more client processes.

According to an embodiment, a request is sent (e.g., by the electronic device) to a server based on the gathered trigger information of a card. Based on the request, the server may deliver a response to the electronic device, which may be received accordingly. The response may include data providing or indicative of the digital content.

The server may determine, from the request, whether the trigger information is valid or not, for example, because it has been revoked or because it has been used in a previous request by the same electronic device or another electronic device. If so, the response may include information about validity of the trigger information, such as an indication of invalidity, which can be displayed to the user using a respective notification. In this case, the server may omit delivering data for rendering the digital content. However, if the server determines that the trigger information is valid, the response may include data for rendering the digital content.

The request may cause the server to invalidate the trigger information for future use. For instance, the request may cause the server to store an indication that the trigger information has been used. Accordingly, when a future request based on the trigger information is received by the same or another electronic device, the server may determine that the trigger information has been used before, using the stored indication. As a consequence, the server may determine that the trigger information is invalid and the response may indicate this to the electronic device.

Accordingly, the server may be enabled to manage redemption of cards and to control digital content to be rendered in response to trigger information from individual cards. This assignment of tasks among servers and electronic devices increases the flexibility of the utilization of cards, as each server may receive related requests from various electronic devices belonging to different recipients of various cards.

In particular, the server may perform one or more of computing, storing and collating recipient interactions, of delivering digital content and of managing the redemption process.

The rendering of the digital content may depend on user interaction with the electronic device, in particular on user input. The rendering of the digital content may be adjusted upon user interaction. For example, at a first point in time the user may direct the camera on the trigger information forming a first recording angle or recording distance, which may result in a particular orientation and/or perspective of the rendered digital content. At a second point in time, the user might have moved the camera with respect to the trigger information, resulting in a different recording angle or recording distance. The electronic device may detect the movement, and based on the detection, it may adjust the rendering of the digital content. Preferably, the adjustment of the rendering of the digital content is performed in real time in order to achieve a fluent embedding of digital content within the recording of the real world, using at least a part of the trigger information.

Additionally or alternatively, based on the gathered trigger information, the electronic device may be receptive to user input for selecting the digital content among a variety of available digital contents, or for interacting with the digital content. For instance, based on the trigger information on the card, two or more options for digital content (e.g., videos) to be rendered may be provided to a user, or a video game may be rendered which can be operated by user interaction.

According to an embodiment, the electronic device may detect user input and report thereon to a server. The server may select a particular available digital content based on the user input and/or the trigger information, and deliver data relating to the selected digital content. In cases where the digital content relates to a video game, the server may assign a particular asset to a user playing a video game, and it may deliver data providing the video game accordingly.

A user profile reflecting one or more user interactions with the electronic device may be generated and updated responsive to further user interaction, e.g., by the server. The digital content rendered by the electronic device may be based on a user profile of the user operating the electronic device. For example, an identification of the user may be sent to the server together with the trigger information. The identification may be used by the server to identify a user profile from the plurality of user profiles, which may be stored by the server or in a central database accessible by the server. The user profile may store various personal information on the user as well as references and/or interests of the user and may further include data representing past behavior and interactions of the user. For instance, when the user profile indicates that the particular user has shown, in previous user interactions, that he or she is particularly interested in some type of content, such as videos of a particular type, e.g., nature documentaries, videos with a particular actor, music of a particular composer or information on particular products or issues, then the digital content to be rendered on the electronic device may be selected accordingly. The method, electronic device and system according to the present disclosure thus provide for an enormous increase of applications for conventional scratch cards.

According to an embodiment, the digital content is at least partially streamed to the electronic device via a communications network. Preferably, the streamed content is provided by a server which may be dedicated to rendering and streaming of digital content responsive to current conditions and display parameters of an electronic device.

This embodiment provides the advantage that less memory of the electronic device is needed and a loading time for the digital content is reduced, so that the digital content can be rendered directly or shortly after the trigger information has been gathered or with a small delay only.

Based on the trigger information, the electronic device may be provided with additional functionality. For instance, based on the trigger information, the server may enable the electronic device to one or more of: temporarily accessing a network resource, temporarily accessing a network service, automatically entering into a draw or lottery, or upgrading an asset in a virtual event rendered by the electronic device. The electronic device may implement the respective functionality, such as to provide additional services to a user. The additional functionality may further be receptive to user interaction such as user input.

The present disclosure thus provides a technology allowing for binding a functionality of an electronic device to digital content to be rendered on the electronic device, which binding can be controlled by means of a card with trigger information.

According to another aspect of the present disclosure, a computer-readable medium having instructions stored thereon is provided, such as one or more non-transitory computer-readable media, wherein said instructions, in response to execution by a computing device, cause said computing device to automatically perform a method of providing digital content on the computing device according to one or more embodiments of the present disclosure. For example, the computing device may be an electronic device according to one or more embodiments of the present disclosure. In particular, the instructions may cause the computing device, when used with a card including trigger information, wherein the trigger information is printed on the card and removably covered by a coating, to gather, by means of a camera of the computing device, the trigger information exposed due to removal of the coating, and based on the gathered trigger information, render the digital content on the electronic device.

As is to be understood, some or several of the features described herein may be combined with each other. In particular, the electronic device of the second aspect and the system according to the third aspect of the present disclosure may be configured to carry out one or more of the particular embodiments of the method according to the first aspect of the present disclosure.

### BRIEF DESCRIPTION OF THE DRAWINGS

Further features and advantages of the present disclosure, as well as the structure and operation of various illustrative embodiments are described in more detail below with reference to the accompanying schematic drawings, wherein

FIG. 1 depicts an exemplary method that may be carried out by an electronic device, in accordance with one embodiment of the present disclosure;

FIG. 2 schematically depicts the utilization of an exemplary system in accordance with one embodiment of the present disclosure;

FIG. 3 exemplarily shows a communication process carried out by an electronic device and a server forming a system for providing digital content in accordance with one embodiment of the present disclosure.

### DETAILED DESCRIPTION

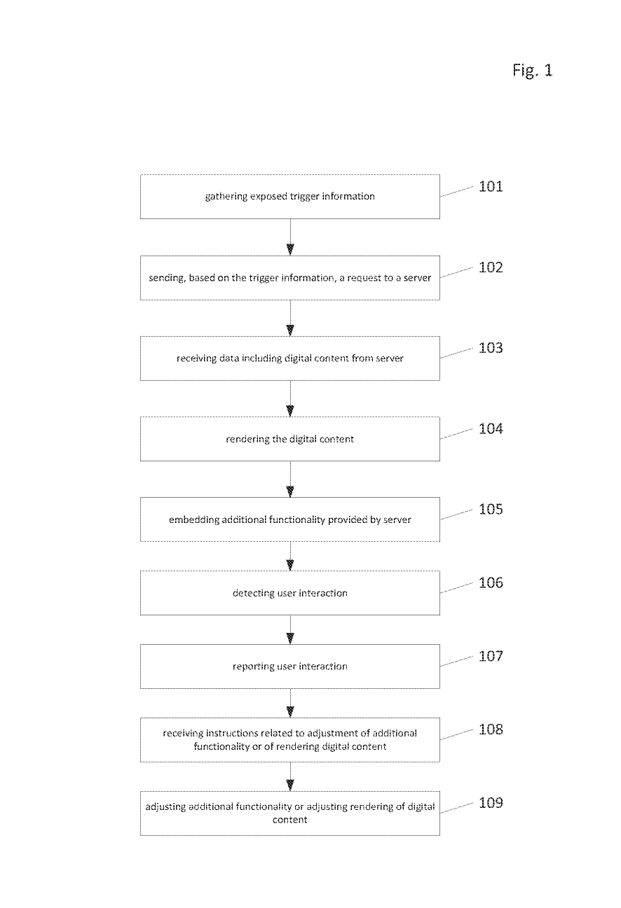

As shown in FIG. 1, in a first step 101, an electronic device may gather trigger information that has been exposed by a user removing a coating on a scratch card. The trigger information may be gathered, in particular, by a camera. For instance, the trigger information may continuously be recorded by the camera of the electronic device. The recording or an image taken by the camera can be analyzed to identify the trigger information. The trigger information may be any kind of visual structure encoding information, such as a one-dimensional or two-dimensional code, for example a QR code or barcode. Furthermore, codes, which change an appearance according to a perspective of the camera, may be used to represent a multi-dimensional code. Preferably, the code may have a visual structure, which may enable a determination of a distance and perspective of the camera with regard to the code. Hence, the code can be utilized as a marker for registering digital content for subsequent rendering. The code can be identified in the image or recording of the camera of the electronic device in order to derive the trigger information. Hence, as used throughout this description, the trigger information may represent the code and the code may correspond to the trigger information.

As a consequence, based on the gathered trigger information, in a step 102, the electronic device may send a request to a server which may be connected to the electronic device by means of a communications network. The request may include data on one or more of the trigger information, such as the trigger information in a numerical form or a hash value derived from the trigger information, information identifying the user, information identifying the electronic device, parameters of the electronic device, such as a current camera perspective, parameters of a display of the electronic device and other data, in any combination.

Based on the request, the server may determine whether the trigger information is valid or not. If the trigger information is valid, the electronic device may, in step 103, receive data delivered by the server, the data including digital content. For example, the electronic device may receive such data as a data stream including rendered digital content which may be adapted according to current parameters of the electronic device.

In step 104, the electronic device renders the digital content, such as by displaying a video or the streamed digital content.

Furthermore, the electronic device may also receive the digital content and may apply augmented reality technology in order to render the digital content, for example by registering the digital content with the trigger information or another marker in the recording of the real world, adjusting the digital content according to current parameters and rendering the digital content as an overlay of the recording of the real world.

As mentioned above, in accordance with an embodiment of the present disclosure, in step 105, additional functionality may be embedded by the electronic device, wherein the additional functionality may be provided, based on the request, to the electronic device by the server, or wherein the additional functionality may be embedded based on a mere instruction received from the server based on the request.

Based on the additional functionality, the electronic device may provide particular services to a user of the electronic device, such as temporal access to a network resource or to a network service, automatically entering into a drawing or lottery, or an upgrade of an asset in a virtual event rendered by the electronic device.

As a particular example, a scratch card applicable in embodiments may relate to offering wireless technology (e.g., free Wi-Fi) for a short period of time. By the method, the electronic device and the system according to the present disclosure, a provider of the wireless technology may be enabled to bind the offer to the consumption of some digital content. Accordingly, in this instance, the provider may enforce that free Wi-Fi is allocated only in conjunction with the user watching, for example, a short video about the company's services. As another particular example, the rendering of digital content (e.g., of a video) may be bound with a functionality of entering into a prize drawing (e.g., a raffle or lottery).

In step 106, user interaction with the electronic device is detected, and in step 107, the user interaction is reported, e.g., to the server. As mentioned above, the user interaction may, for instance, relate to altering an orientation of the camera of the electronic device to the trigger information on the scratch card, or to a particular user input into the electronic device.

Based on the reported user interaction, the server may send, to the electronic device, instructions related to one or more adjustments regarding the rendering of the digital content, or concerning the additional functionality embedded by the electronic device. The server may also directly adjust the digital content in response to the user interaction, for example, by adjusting a server-side rendering and streaming of the digital content. Accordingly, the streamed rendered digital content may be directly overlaid on a recording in the electronic device without requiring a local computation on the electronic device. In step 108, the instructions are received by the electronic device, and in step 109, the adjustment(s) are realized accordingly.

As is to be understood, in accordance with the present disclosure, some of the process steps may be dispensable, and the various steps might be carried out in a different order.

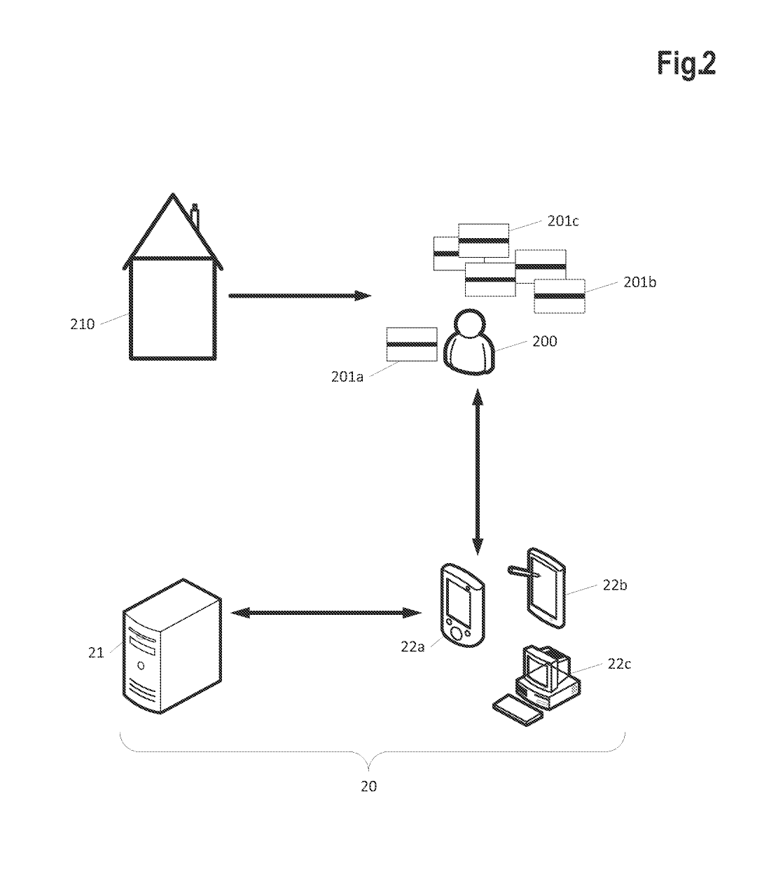

FIG. 2 schematically shows an exemplary system in accordance with the present disclosure. The system 20 may include a server 21 and electronic devices 22a, 22b and 22c, wherein different types of electronic devices are exemplarily depicted. Each of the devices may comprise a camera (not shown) and may communicate with the server by a communications network. As indicated in FIG. 2, electronic device 22a may be used by a user 200 holding a scratch card 201a. As is to be understood, devices 22b and 22c could likewise be used by the same or another user of one or more further scratch cards, such as scratch cards 201b or 201c, for instance. The scratch cards 201a-201c include respective trigger information which is removably covered by a coating. The scratch cards 201a-201c are printed, issued and published to recipients by card provider 210.

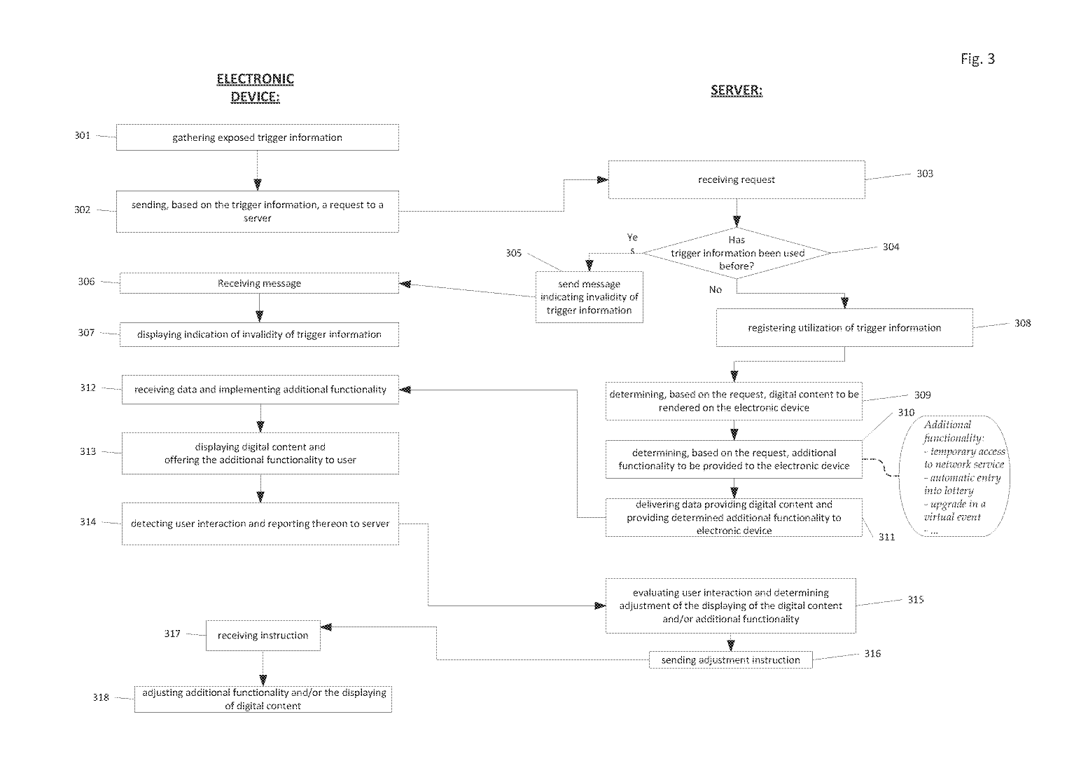

As indicated by the arrows between user 200 and electronic device 22a, the user 200 may interact with the electronic device 22a. In accordance with the present disclosure, user 200 may direct the camera of electronic device 22a to the scratch card 201a, such that the electronic device can gather the trigger information the user has exposed by removing a coating covering the trigger information on the scratch card 201a. Electronic device 22a may further communicate with the server 21 as further detailed with respect to FIG. 3. Therein, server 21 may manage the redemption of the scratch cards 201a-201c, the delivery of digital content to electronic devices 22a-22c and the recipient interaction.

As a consequence, the electronic device 22a renders digital content, such as augmented reality or digital proposition(s). The user 200 may further interact with the electronic device 22a, which may report to the server 21 on the interaction and react on resulting instructions of server 21, as detailed above.

In FIG. 3, a course of actions carried out by an electronic device and a server, such as one of electronic devices 22a-22c and server 21 of FIG. 2, respectively, in accordance with the present disclosure are exemplarily shown. Therein, the steps carried out by the electronic device are depicted on the left hand side, whereas steps carried out by the server are depicted on the right hand side.

The shown course of actions begins with step 301, where the electronic device gathers trigger information which has been exposed from a scratch card, by a user removing a coating of the trigger information. Based on the gathered trigger information, the electronic device sends, in step 302, a request to the server.

In step 303, the server receives the request, and in step 304, the server determines whether the trigger information has been used (or gathered) before, e.g., by consulting respective records in a memory of the server. If the server determines that the trigger information has been used (gathered) before and thus is invalid, the server sends, in step 305, a message indicating the invalidity of the trigger information to the electronic device. In step 306, the electronic device receives the message, and in step 307, it displays an indication of the invalidity to the user.

If, however, the server determines, in step 304, that the trigger information has not been used so far, the server registers, in step 308, the utilization of the trigger information. As a consequence, when the trigger information will be used (gathered) later on, the server will be able to recognize the repetition and determine that, at that time, the trigger information will not be valid any more.

In step 308, the server thus implements a redemption of the trigger information.

In step 309, based on the request, the server determines digital content to be rendered on the electronic device. For example, the server may select a particular digital content, such as audio, video and/or gaming content that is to be rendered on the electronic device, wherein the digital content has been related to the trigger information, e.g., by a provider of the scratch card. For instance, based on the request, the server may query a database or table assigning the trigger information to the particular digital content.

In step 310, the server further determines at least one additional functionality that may be provided, by the server, to the electronic device. Due to such additional functionality, the electronic device may provide services such as temporal access to a network service, automatic entry into a lottery, an upgrade in a virtual event or the like. Analogously to the above described possible determination of digital content, determining the additional functionality may comprise querying a database or table assigning the trigger information to at least one additional functionality.

In step 311, the server delivers data providing the determined digital content and the determined at least one additional functionality. In step 312, the electronic device receives the data and implements the at least one additional functionality, and in step 313, the electronic device renders and/or displays the digital content and offers the additional functionality, such as the related services, to a user of the electronic device.

In step 314, the electronic device detects user interaction, such as user input or a movement of the electronic device, and reports the user interaction to the server. The user interaction may relate to the rendered data. For instance, it may include a selection of a desired service provided by means of the additional functionality, or it may relate to the rendered digital content, such as to a selection thereof or to a perspective in which the digital content is to be rendered.

The server evaluates the user interaction in step 315, and determines accordingly that an adjustment of the rendering of the digital content, an adjustment of the additional functionality or both is appropriate. In step 316, the server sends a related adjustment instruction, which is received, by the electronic device, in step 317. Responsive thereto, the electronic device adjusts the additional functionality or the rendering and/or display of the digital content or both.

As is to be understood, in accordance with the present disclosure, some of the process steps described with regard to FIG. 3 may be dispensable or modified, and the various steps might be carried out in a different order.

Embodiments and examples of the present disclosure enable an advanced distribution of scratch cards by publishers, businesses, organizations and/or sponsors in the same way as scratch cards always have been and for similar business reasons, for example, to reward customers, generate new business, create products, services and/or brand awareness and others. Once the trigger, which may correspond to the trigger information or code discussed above, is revealed, it may be regarded as part of an AR system/technology and once the trigger or code comes into a camera's live view the preprogrammed digital content may be delivered to the recipient. The delivered content can take any type and format of digital proposition, and in its exact nature could depend entirely on the message the card provider intended to convey to the recipient. Embodiments of the present disclosure also allow for a variety of joint publisher, provider and/or sponsor participation. For example, restaurant A could advertise in hard copy print on one side of a card and business B could offer a digital proposition via the AR scratch element and technology on the reverse side, which may correspond to the trigger or trigger information. As discussed above, the server may compute, store and collect recipient interactions, which could also allow for accurate in-campaign and post-campaign monitoring and analysis.

Embodiments of the present disclosure may be applied in several use cases. Furthermore, aspects of the use cases may be incorporated in embodiments of the present disclosure in any combination.

According to a first use case, user A may receive a physical scratch card in an airport lounge, which may be handed out by a business that wants to raise awareness about its Wi-Fi services to business travelers and as such offering free Wi-Fi for a short period of time. In this instance, the recipient may be required to watch a short video about the company's services and for doing so, may receive free Wi-Fi for a period of time while being in the airport lounge.

According to a second use case, two businesses located in close proximity to each other may decide to run a joint participation campaign. Business A may be a fast food chain and may decide to advertise an offer in hard copy print on one side of a scratch card. Business B may be an electronics store and may offer an AR offering on the reverse side of the card. Recipients of the scratch card may watch a launch video for the latest smart phone and in doing so may be automatically entered into a prize drawing to win a phone.

Even though two use cases have been described, it is to be understood that embodiments of the present disclosure can be applied in various other scenarios and the present invention is not limited by the two use cases described above.

While some embodiments have been described in detail, it is to be understood that the aspects of the present disclosure can take many forms. In particular, the claimed subject matter may be practiced or implemented differently from the examples described and the described features and characteristics may be practiced or implemented in any combination. The embodiments shown herein are intended to illustrate rather than to limit the invention as defined by the claims.

1. A method of providing digital content on an electronic device, the method for use with a card including trigger information, wherein the trigger information is printed on the card and removably covered by a coating, the method comprising:
gathering, by a camera, the trigger information exposed due to removal of the coating; and
based on the gathered trigger information, rendering the digital content on the electronic device.

2. The method of claim 1, further comprising adjusting the rendered digital content based on user interaction with the electronic device.

3. The method of claim 1, further comprising selecting the digital content based on user interaction with the electronic device.

4. The method of claim 1, further comprising providing, based on the trigger information, additional services of the electronic device to a user thereof.

5. The method of claim 1, further comprising
recording the trigger information;
overlaying the recorded trigger information with the digital content; and
displaying the recorded trigger information with the overlaid digital content on the electronic device.

6. The method of claim 1, wherein the digital content is rendered on a display of the electronic device using augmented reality techniques.

7. The method of claim 1, wherein the digital content is streamed via a communications network to the electronic device.

8. The method of claim 1, further comprising:
sending, based on the trigger information, a request to a server; and
receiving, from the server, data providing the digital content.

9. The method of claim 8, wherein the digital content is further based on a user profile stored by the server, the user profile reflecting one or more user interactions with the electronic device.

10. The method of claim 8, wherein the request causes the server to invalidate the trigger information for future use.

11. An electronic device comprising a processor, a camera and a display, the electronic device being adapted to provide digital content when used with a card including trigger information, wherein the trigger information is printed on the card and removably covered by a coating, wherein the electronic device is configured to:
gather, by means of the camera, the trigger information exposed due to removal of the coating; and
render the digital content based on the gathered trigger information.

12. A system for use with a plurality of cards, each including trigger information printed on each card and removably covered by a coating, the system comprising at least one electronic device and at least one network server configured to communicate with the at least one electronic device, wherein each of the at least one electronic device is configured to:
gather, by means of a camera of the electronic device, trigger information exposed due to removal of a coating of one of the plurality of cards; and
render digital content based on the gathered trigger information.

13. The system of claim 12, wherein at least one electronic device is further configured to record the trigger information, overlay the recorded trigger information with the digital content; and display the recorded trigger information with the overlaid digital content on the electronic device.

14. The system of claim 12, wherein the digital content is rendered on a display of the electronic device using augmented reality techniques.

15. The system of claim 12, wherein the digital content is streamed via a communications network to the electronic device.

16. The system of claim 12, wherein at least one electronic device is further configured to send, based on the trigger information, a request to one of the at least one network server; and wherein at least one network server is configured to send, based on a request, a response to an electronic device sending the request.

17. The system of claim 16, wherein at least one network server is configured to generate, store and update a plurality of user profiles reflecting user interactions of users with electronic devices, and wherein the response is further based on a user profile of a user of the electronic device sending the request.

18. The system of claim 16, wherein at least one network server is further configured to invalidate, based on the request, the trigger information for future use.

19. The system of claim 12, wherein the plurality of cards are registered at at least one network server.

20. The system of claim 12, wherein the plurality of cards include scratch cards.
